(19) United States
(12) Patent Application Publication
(10) Pub. No.: US 2011/0088366 A1
(43) Pub. Date: Apr. 21, 2011

(54) ROTARY RAKING OR SWEEPING IMPLEMENT

(76) Inventor: ALTON GRAETZ, Pound, WI (US)

(21) Appl. No.: 12/906,301

(22) Filed: Oct. 18, 2010

Related U.S. Application Data
(60) Provisional application No. 61/252,237, filed on Oct. 16, 2009.

(51) Int. Cl. A01D 78/08

(52) U.S. Cl. 56/366

(57) ABSTRACT

The present invention provides an improved raking or sweeping implement such as a yard and trail rake that is configured to be pulled by an all-terrain vehicle (ATV), lawn mower, or the like. Rake can include a frame portion connected to a rotary portion. Frame portion can include an attachment mechanism for attachment to a pulling mechanism, such as an ATV. Rotary portion can include a drive shaft, a plurality of rotary shafts with raking tines, and a planetary gear system for driving the rotary shafts as the rotary portion is rotated. Rotary portion can be rotated by engaging a tire of frame portion with a drive mechanism connected to drive shaft such that rotation of the tire caused by pulling the rake causes the rotary portion to rotate. As rotary portion rotates, planetary gear system causes raking tines to rotate forwardly, raking up debris.

### PRIORITY CLAIM

This application claims the benefit of U.S. Provisional Application No. 61/252,237, filed Oct. 16, 2009, which is hereby fully incorporated herein by reference.

### FIELD OF THE INVENTION

The present invention relates to raking or sweeping implements and more particularly to rotary rakes for raking yards and trails.

### BACKGROUND OF THE INVENTION

In order to maintain a grass lawn or a trail in good condition, it is often desirable to regularly remove from the area obstructing materials such as moss, leaves, loose grass, acorns, etc. Removal of such materials has traditionally been carried out manually using a hand-operated lawn rake of the kind well known in the art comprising a hand-held elongate shaft which carries a rake-head at one end. The head generally includes a plurality of elongate tines which are typically splayed outwardly with respect to one another from the end of the shaft. The use of a traditional hand rake, however, is very time-consuming and may not be practical for use on larger areas.

There are also rakes for agricultural and commercial applications that are designed to be pulled by tractors. However, such rakes are large and expensive and may be unsuitable for smaller scale applications such as lawns and trails. Such rakes often also require a separate power source from the tractor and therefore greatly increase the cost of the raking operation.

### SUMMARY OF THE INVENTION

The present invention provides an improved raking or sweeping implement such as a yard a trail rake that is configured to be pulled by an all-terrain vehicle (ATV), lawn mower, or the like. The rake enables an area such as a yard or trail to be raked or swept in a much more time-effective manner than traditional hand rakes and provides a much simpler and cost-effective solution than agricultural rakes. A rotary portion of the rake having a plurality of raking tines is driven by the rotation of one of the rake's tires as it is being pulled, so no separate power source is required for operating the rake. The rotary portion can be angled with respect to the direction of travel of the rake so that piles of grass, leaves, etc. are swept to a side of the rake.

The present invention provides an improved raking or sweeping implement such as a yard and trail rake that is configured to be pulled by an all-terrain vehicle (ATV), lawn mower, or the like. The rake can include a frame portion connected to a rotary portion. The frame portion can include an attachment mechanism for attachment to a pulling mechanism, such as an ATV. The rotary portion can include a drive shaft, a plurality of rotary shafts with raking tines, and a planetary gear system for driving the rotary shafts as the rotary portion is rotated. The rotary portion can be rotated by engaging a tire of the frame portion with a drive mechanism connected to drive shaft such that rotation of the tire caused by pulling the rake causes the rotary portion to rotate. As the rotary portion rotates, the planetary gear system causes the raking tines to rotate forwardly, raking up debris. The rake can also be adapted to include sweeping elements such as brooms in place of raking tines to allow hard surfaces to be swept with the rake.

### BRIEF DESCRIPTION OF THE DRAWINGS

The present disclosure will be more completely understood and appreciated by referring to the following more detailed description in conjunction with the accompanying drawings of which:

FIG. 1 is a perspective view of a yard and trail rake according to an embodiment of the present invention.

FIG. 2 is a perspective view of a yard and trail rake according to an embodiment of the present invention.

FIG. 3 is a partial perspective view of a yard and trail rake according to an embodiment of the present invention depicting the engagement of the frame portion with the drive means of the rotary portion.

FIG. 4 is an elevational view of a planetary gear system of a yard and trail rake according to an embodiment of the present invention.

### DETAILED DESCRIPTION OF THE DRAWINGS

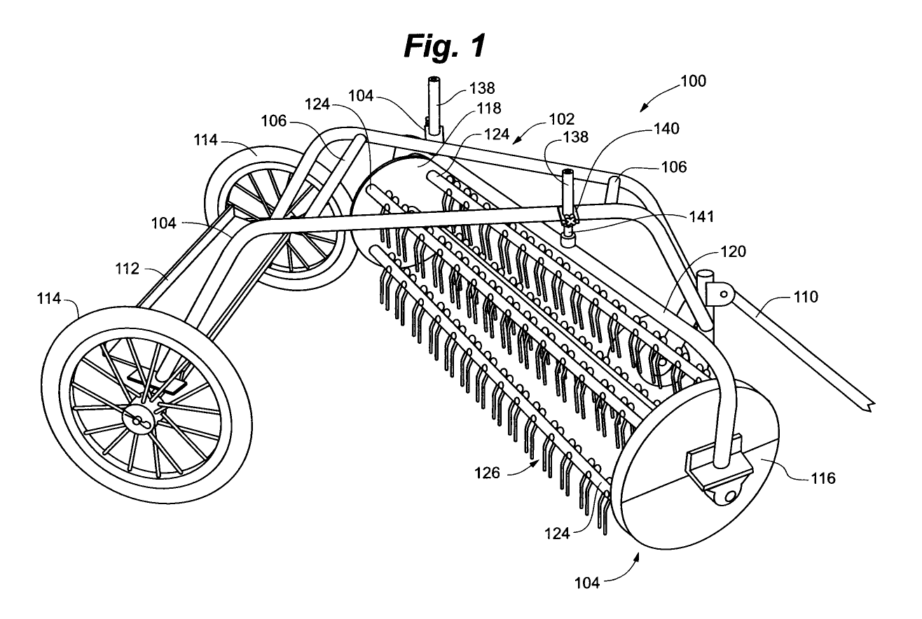

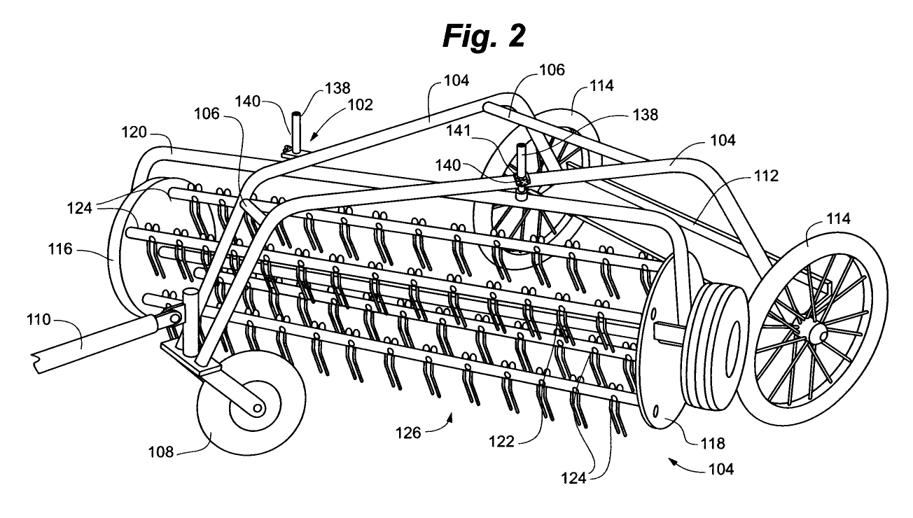

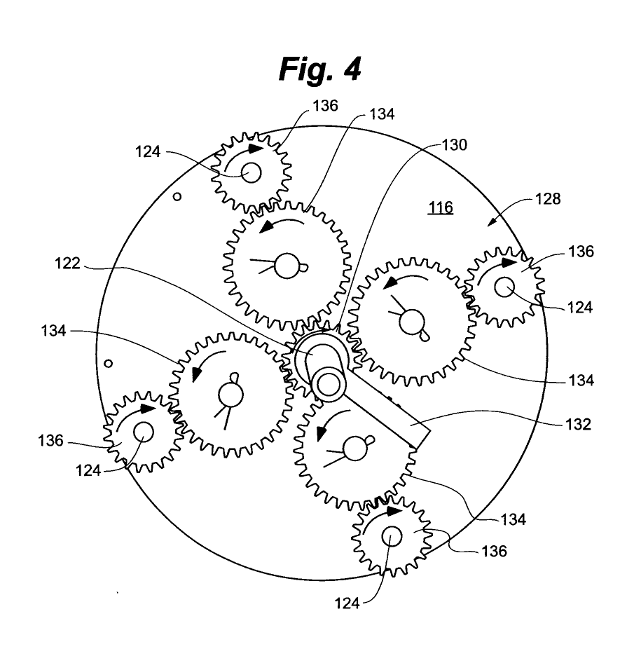

Referring to FIGS. 1-4, a rotary yard and trail rake 100 according to an embodiment of the present invention generally includes a frame portion 102 and a rotary portion 104. Rake 100 can be used to rake leaves, acorns, pine needles, grass, gravel and other light debris on yards and trails. Rake 100 can be pulled by any available means, such as, for example, an all-terrain vehicle (ATV) or similar vehicle, a lawnmower, or a horse.

The frame portion 102 of rake 100 includes a pair of curved support members 104 connected to each other by one or more cross members 106. Support members 104 connect to a front wheel or tire 108 at a forward portion of frame 102. An attachment mechanism 110, such as pull tube 110, also connects to support members 104 at a forward portion of frame 102. Pull tube 110 can be used to attach rake 100 to a pulling mechanism, such as, for example, an ATV to provide for translational movement of rake 100. At a rear portion of frame 102, support members 106 connect to a weight tray 112. A wheel or tire 114 can be positioned on each side of weight tray 112.

Rotary portion 104 includes a pair of hubs 116, 118 connected by a cross bar 120. A central drive shaft 122 extends between hubs 116, 118 and can be surrounded by a plurality of rotary shafts 124. In one embodiment, rotary portion 104 includes four rotary shafts 124 evenly distributed around drive shaft 122. Rotary shafts 124 include a plurality of raking tines 126 and can also be adapted to include sweeping elements such as brooms.

Rotary portion 104 can include a planetary gear system 128 on hub 116 for rotating rotary shafts 124. Planetary gear system 128 includes a drive gear 130 attached to drive shaft 122. A lock bar 132 can also be connected to drive shaft 122 to secure drive shaft 122 and ensure proper rotation of rotary portion 104. Drive gear 130 meshes with a plurality of secondary gears 134 connected to hub 116. Secondary gears 134 mesh with a plurality of rotary shaft gears 136 connected to rotary shafts 124. Thus, if the drive gear 130 is rotated clockwise as indicated, the secondary gears rotate in the reverse direction, causing the rotary shaft gears 136 and rotary shafts 124 to also rotate clockwise. This allows the tines 126 to sweep forwardly in relation to the rotation of the rotary portion 104. The gear size and/or positioning of planetary gear system 128 can be adjustable to allow an operator to adjust the sweep angle of the tines 126. In one embodiment, the tines 126 are always pointing straight down as they contact the ground.

Rotary portion 104 can be adjustably connected to frame portion 102. In one embodiment, rotary portion 104 is connected to frame portion 102 via a pair of shafts 138 extending upwardly from rotary portion 104. Shafts 138 can be removably inserted into locking collars 140 on frame portion and affixed together by locking mechanisms 141. Locking mechanisms 141 can comprise any means for engaging shafts 138 within locking collars 140. In one embodiment, locking mechanisms 141 include a knob that is tightened to engage shafts 138 within locking collars 140. This enables frame portion 102 and rotary portion 104 to be removably attached to one another and enables adjustment of the height of rotary portion 104 relative to the ground or other surface to be raked or swept.

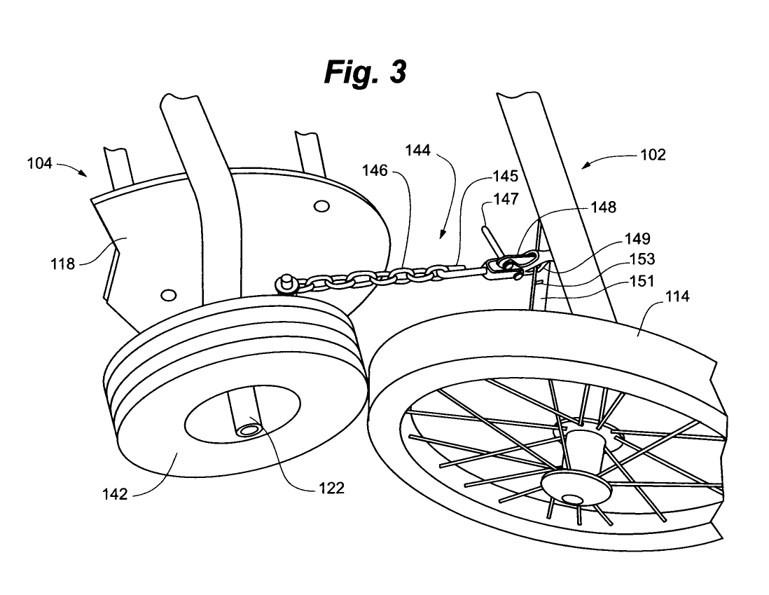

To provide for rotation of rotary portion 104 as rake 100 is pulled, one of tires 114 can be brought into engagement with a drive mechanism 142 such as drive wheel 142 affixed to rotary portion 104 at drive shaft 122 adjacent hub 118 as can be seen most clearly in FIG. 3. Tire 114 and drive wheel 142 can be held in engagement with an engagement means 144 that can be manually engaged or disengaged. In one embodiment, engagement means 144 includes a linkage 146, such as a chain, extending from rotary portion 104 and a connector 148. Connector 148 can include a first hook 145 for connecting to linkage 146 and a second hook 149 for connecting to frame portion 102. In one embodiment, hook 149 can be releasably inserted into one of a plurality of slots 153 in a ledge 151 on frame portion 102. Connector 148 can also include a handle 147 to provide for easier insertion and removal of hook 149 in slots 153. A plurality of slots 153 enables adjustment in the engagement between the drive wheel 142 and the tire 114. When the tire 114 and drive wheel 142 are engaged, as the rake 100 is pulled forward in a direction of travel, the tire 114 rotates forwardly. This causes the drive wheel 142 to rotate in the opposite direction, or backwards and, via the planetary gear system described above, causes the rotary shafts 124 to also rotate the tines 126 forwardly in the direction of travel as they contact the ground to sweep debris forward. When tire 114 is disengaged from drive wheel 142, rake 100 can be pulled such that rotary portion 104 does not rotate. This may be desirable when between raking jobs in order to transport rake 100. In addition to drive wheel 142, drive mechanism 142 can comprise any other generally circular object that can provide for continual rotation of rotary portion 104 when engaged by wheel 114. By effecting rotation of rotary portion 104 via movement of rake 100, rotary portion 104 can be rotated without use of a separate power source.

In operation, a user connects the rake 100 to an ATV or other means for pulling rake 100 via pull tube 110. The height of rotary portion 104 relative to the ground or other surface can be set via adjustment of locking mechanisms 141. The desired height of rotary portion may be determined by the type of operation that is going to be performed with rake. For example, a higher position may be desirable for raking leaves than for heavy thatching. Weight tray 112 may then be used to coordinate the height of tires 114 with the height of drive wheel 142 on rotary portion 104. As the rotary portion 104 is lowered for various operations, it may be necessary to hold tires 114 more firmly towards the ground to ensure proper engagement of tire 114 with drive wheel 142. This can be done by adding weight to weight tray 112. Weight tray 112 can accommodate any known means for providing added weight, such as, for example, sandbags, concrete blocks, or rocks.

Tire 114 can then be engaged with drive wheel 142. This can be done by swiveling frame portion 102 until tire 114 comes into contact with drive wheel 142. Tire 114 and drive wheel 142 are then locked together with engagement means 144. As rake 100 is pulled forwardly, tines 126 are brought forwardly in a sweeping motion to rake debris. As can be seen in the Figures, when drive wheel 142 is engaged with tire 114, rotary portion 104 can be aligned at an angle with frame portion 102. In operation, tires 114 will be aligned with the direction of travel of the pulling mechanism that is pulling the rake 100 via pull tube 110. Thus, rotary portion 104 will be aligned at an angle to the direction of travel of the pulling mechanism and the rake 100. This allows grass, leaves, and other debris to be swept into a pile alongside the rake 100 and pulling mechanism.

In other embodiments, various other mechanisms can be substituted for raking tines 126. Rake 100 can be used for any application that can benefit from a raking or sweeping type motion as described. For example, rotary portion can be configured to include brooms or broom-like elements to allow for sweeping of flat surfaces such as driveways and parking lots.

In one embodiment, rake 100 can be comprised primarily of steel 100. In such an embodiment, the various components of rake 100 can be welded together.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A raking or sweeping implement, comprising:
a frame portion including an attachment mechanism adapted to attach the implement to a pulling mechanism for providing translation movement of the implement in a direction of travel and at least one tire adapted to provide contact between the implement and a surface along which the implement is to be pulled;
a rotary portion connected to the frame portion, the rotary portion including a pair of spaced apart hubs and a plurality of rotary shafts extending between the hubs, the rotary shafts each including a plurality of raking or sweeping elements; and
a drive mechanism operably connected to the rotary portion, such that, when the tire of the frame portion is engaged with the drive mechanism as the implement is being pulled in the direction of travel, a rotation of the tire in a first direction causes a rotation of the rotary portion in second direction opposite of the first direction, such that the raking or sweeping elements attached to the shafts are moving in the direction of travel of the implement as they contact the surface.

2. The implement of claim 1, further comprising a gear system operably connected to the rotary portion, the gear system adapted to translate the rotation of the rotary portion in the second direction into an additional rotation of the rotary shafts in the second direction as the rotary portion is rotated.

3. The implement of claim 2, wherein the gear system is configured such that the raking or sweeping elements rotate such that they are oriented straight down towards the surface as they contact the surface.

3. (canceled)

4. The implement of claim 1, wherein, when the tire of the frame portion is engaged with the drive mechanism, the rotary portion is oriented at an angle relative to the frame portion such that as the implement is being pulled in the direction of travel debris is raked or swept to a side of the implement.

5. The implement of claim 1, wherein the rotary portion is adjustably connected to the frame portion such that a distance between the rotary portion and the surface can be adjusted.

6. The implement of claim 1, wherein the rotary portion is removably attached to the frame portion.

7. The implement of claim 1, further comprising a clamping mechanism adapted to hold the drive mechanism in engagement with the tire.

8. The implement of claim 1, wherein the frame includes two tires at a rear portion of the frame and a weight tray extends between the two tires.

9. A method of raking or sweeping an area, comprising:
connecting a pulling mechanism to an attachment mechanism of a raking or sweeping implement, the implement including a frame portion having at least one tire adapted to provide contact between the implement and a surface along which the implement is to be pulled and a rotary portion connected to the frame portion and having a pair of spaced apart hubs and a plurality of rotary shafts extending between the hubs, the rotary shafts each including a plurality of raking or sweeping elements;
engaging the tire of the frame portion with a drive mechanism operably connected to the rotary portion; and
pulling the implement along the surface with the pulling mechanism in a direction of travel such that a rotation of the tire in a first direction causes a rotation of the rotary portion in second direction opposite of the first direction, such that the raking or sweeping elements attached to the shafts are moving in the direction of travel of the implement as they contact the surface.

10. The method of claim 9, wherein the step of pulling the implement includes causing a gear system operably connected to the rotary portion to translate the rotation of the rotary portion in the second direction into an additional rotation of the rotary shafts in the second direction as the rotary portion is rotated.

11. The method of claim 9, further comprising disengaging the tire of the frame portion from the drive mechanism and pulling the implement such that the rotary portion does not rotate.

12. The method of claim 9, further comprising adjusting a connection between the frame portion and the rotary portion to change a distance between the rotary portion and the surface.

13. The method of claim 10, further comprising adjusting the gear system to change an angle at which the raking or sweeping elements are oriented relative to the surface when they contact the surface.

14. The method of claim 9, wherein the step of engaging the tire of the frame portion with the drive mechanism includes locking the drive mechanism in engagement with the tire.

15. The method of claim 9, wherein the frame includes two tires at a rear portion of the frame and a weight tray extends between the two tires and further comprising placing a weighted item on the weight tray.

16. The method of claim 9, further comprising disconnecting the rotary portion from the frame portion and connecting a different rotary portion to the frame portion.

17. A raking or sweeping implement, comprising:
a frame portion including means for attaching the implement to a means for pulling the implement in a direction of travel and at least one rotatable means for engaging a surface along which the implement is to be pulled;
a means for raking or sweeping rotatably connected to the frame portion; and
a drive means for rotating the means for raking or sweeping, wherein when the means for engaging a surface is engaged with the drive means as the implement is being pulled in the direction of travel, a rotation of the means for engaging in a first direction causes a rotation of the means for raking or sweeping in a second direction opposite of the first direction, such that the means for raking or sweeping is moving in the direction of travel of the implement as it approaches the surface.

18. The implement of claim 17, wherein the means for raking or sweeping includes a plurality of raking or sweeping elements, and further comprising a means for translating the rotation of the means for raking and sweeping into an additional rotation of the raking or sweeping elements in the second direction.

19. The implement of claim 17, further comprising a means for adjusting a distance between the means for raking or sweeping and the surface.

20. The implement of claim 17, further comprising a means for releasably locking the means for engaging a surface in engagement with the drive means for rotating the means for raking or sweeping.

21. The implement of claim 1, wherein, if the tire of the frame portion is not engaged with the drive mechanism as the implement is being pulled in the direction of travel, the rotary portion does not rotate.
